(19) United States
(12) Patent Application Publication
(10) Pub. No.: US 2026/0368657 A1
(43) Pub. Date: Nov. 19, 2026

(54) Locker Assignment Systems and Methods

(71) Applicant: Locker Room Solutions, LLC, Lisle, IL (US)

(72) Inventor: Thomas A. Condon, Lisle, IL (US)

(21) Appl. No.: 19/723,806

(22) Filed: Jun. 29, 2026

Related U.S. Application Data
(63) Continuation of application No. PCT/US2024/062221, filed on Dec. 29, 2024.
(60) Provisional application No. 63/615,885, filed on Dec. 29, 2023.

(51) Int. Cl. G06Q 10/02; G06N 20/00; G07C 9/00; G07F 17/12

(52) U.S. Cl. CPC G06Q 10/026; G06N 20/00; G07C 9/00571; G07F 17/12; G07C 2209/08

(57) ABSTRACT

A locker assignment system can include a plurality of lockers at a location having corresponding locker devices. In some embodiments, data collected by the locker devices can be used to train a machine learning model or adjust software configurations. In some embodiments, the system receives a request from a user to reserve a locker for a particular period of time, selects a particular locker from the plurality of lockers, obtains usage information from the locker device for the user for the location for the particular period of time, retrains the machine learning model and/or adjusts software configurations using the usage information. In some embodiments, the locker is selected using user preferences and/or the system's prediction on when the user will enter/leave the facility and whether lockers adjacent to the selected locker will be in use at the time.

### CROSS-REFERENCE TO RELATED APPLICATION(S)

This application is a continuation of and claims priority benefits from International Patent Application PCT/US2024/062221, filed on Dec. 29, 2024, entitled “Locker Assignment Systems and Methods”. The '221 application claims priority benefits from U.S. Application Ser. No. 63/615,885 filed on Dec. 29, 2023, entitled “Locker Assignment System and Method”. This application also claims priority from the '885 application. The '221 and '885 application are hereby incorporated by reference herein in their entireties.

### FIELD OF THE INVENTION

Many locations, such as health clubs or gyms, have lockers in a locker room or other location that are shared by users. The lockers are often not assigned to the users. Instead, a user often has to look for an available locker. When selecting a locker, users prefer to use a locker that is not next to a locker that is currently being used by another person. For some users, having to use a locker while others are using adjacent lockers is inconvenient, embarrassing, and/or undesirable and can detract from the user's overall experience using the facility.

While the ability to avoid choosing a locker next to someone else is often possible when a user arrives at a locker room, a user does not know who will be using the locker room when the user returns to his or her locker before leaving the facility. Adjacent locker usage is a problem for facilities looking to achieve high member retention through high customer satisfaction rates due to the peak-end rule. The peak-end rule is a psychological heuristic where people evaluate an experience based on its most intense point (the peak) and its conclusion (the end), rather than considering the entire experience. A negative experience at the end of an event, such as having to change next to someone when leaving a locker room, will negatively impact how the user remembers the entire experience.

What is needed are systems and methods for helping assign lockers to users such that users are unlikely (or at least less likely) to end up changing directly next to others both when arriving at a facility and when leaving a facility. In addition, systems and methods that inform a user how busy a facility is, or will likely be in the future, can aid in helping users determine a preferable time to visit a facility based on their own comfort levels.

Users also need to remember the locker they have chosen or been assigned (often via a locker number) for when they are finished using the facility. This can be difficult for some users, as they may forget the locker they have chosen and/or can have a difficult time finding it when they return to the locker room. Systems and methods for helping user's recall their assigned locker are also disclosed.

### SUMMARY OF THE INVENTION

In some embodiments, locker assignment systems and methods are provided for selecting a particular locker from a plurality of lockers that can be located in a location such as a locker room. In some embodiments, the user may not know when the lockers adjacent to a given locker will be in use while the user is visiting the locker location. In some embodiments, the systems and methods seek to eliminate, minimize, or at least reduce the likelihood that a first user will be using a locker adjacent to second user when the first user arrive at the locker room and/or when the user returns to the locker room before departing the facility.

In some embodiments, a system can include a plurality of lockers having a locker device comprising a wireless communication device, a memory chip storing computer-readable instructions, and at least one processor to execute the instructions to train a machine learning model using artificial intelligence (AI) software (such as neural networks or other AI systems), optimization software (such as CPLEX, Gurobi, SCIP or other optimization/solver software) and/or proprietary software. In some embodiments, the model is trained using visitor usage data for a location having the plurality of locker devices. In some embodiments, the system can receive a request from a user for a locker having one of the locker devices at the particular location for a particular period of time. In some embodiments, the system can determine user profile preferences for the user for the location. In some embodiments, the system selects a particular locker from the plurality of lockers for the user based on the machine learning model and/or the user profile preferences. In some embodiments, the system obtains usage information from the locker device for the user for the particular period of time and, in at least some embodiments, retrains the machine learning model using the usage information from the locker device for the user for the particular period of time.

In some embodiments, a method can include training, by at least one processor, a machine learning model using artificial intelligence software such as neural networks or other AI systems, optimization software (such as CPLEX, Gurobi, SCIP or other optimization/solver software) and/or proprietary software and/or perhaps usage data for a location having a plurality of locker devices. In some embodiments, each locker device comprising a wireless communication device, receiving, by the at least one processor, a request from a user for a locker having one of the locker devices at the particular location for a particular period of time. In some embodiments, the method involves determining/selecting, by the at least one processor, a particular locker from the plurality of lockers for the user based on the machine learning model. using AI software, optimization software and/or or proprietary software. In some embodiments, the method involves obtaining, by the at least one processor, usage information from the locker device for the user for the particular period of time, and retraining, by the at least one processor, the machine learning model using the usage information from the locker device for the user for the particular period of time.

In some embodiments, a non-transitory computer-readable storage medium can have instructions stored thereon that, when executed by at least one computing device cause the computing device to perform operations, the operations including training a machine learning model using AI software (such as neural networks or other AI systems), optimization software (such as CPLEX, Gurobi, SCIP or other optimization/solver software) and/or proprietary software using visitor usage data for a location having a plurality of locker devices. In some embodiment, each locker device includes a wireless communication device. In some embodiments, the operations include receiving a request from a user for a locker having one of the locker devices at the particular location for a particular period of time, determining user profile preferences for the user for the location, selecting a particular locker from the plurality of lockers for the user based on the machine learning model and/or user profile preferences, obtaining usage information from the locker device for the user for the particular period of time, and/or retraining the machine learning model using the usage information from the locker device for the user for the particular period of time.

These and other aspects, features, and benefits of the present disclosure will become apparent from the following detailed written description and aspects taken in conjunction with the following drawings, although variations and modifications thereto can be affected without departing from the spirit and scope of the concepts of the disclosure.

### BRIEF DESCRIPTION OF THE DRAWINGS

The accompanying drawings illustrate embodiments and/or aspects of the disclosure and, together with the written description, serve to explain the principles of the disclosure.

FIG. 1A is a block diagram of two rows with upper and lower lockers in an example locker room.

FIG. 1B is a block diagram of three rows of lockers with upper and lower lockers in a U-shape in an example locker room.

FIG. 2 is a block diagram of a locker assignment system.

FIG. 3 is a perspective view of a locker room.

FIG. 4A is a block diagram of an example of a locker device of the locker assignment system.

FIG. 4B is a front view of an option keypad used with the locker device of FIG. 4A.

FIG. 5 is a bar graph showing an example usage of a locker room according to an example of the instant disclosure.

FIG. 6 is a flowchart of a process for assigning a locker to a user by a locker assignment system according to an example of the instant disclosure.

FIG. 7 is an example user interface in which a user can reserve a locker.

FIG. 8 is another example user interface showing information regarding an assigned locker to an end user.

FIG. 9 is another example user interface showing information regarding an assigned locker and giving the user the option to extend their reserved locker time.

FIG. 10 is another example user interface providing information about the number of individuals currently at the facility.

FIG. 11 is another example user interface where a user can view actual and/or predicted historical usage of a facility.

FIG. 12 shows an example of a system for implementing certain aspects of the present technology.

### DETAILED DESCRIPTION OF ILLUSTRATIVE EMBODIMENT(S)

The present disclosure is more fully described below with reference to the accompanying figures. The following description is exemplary in that several embodiments are described (e.g., by use of the terms “preferably,” “for example,” or “in one embodiment”); however, such should not be viewed as limiting or as setting forth the only embodiments of the present disclosure, as the disclosure encompasses other embodiments not specifically recited in this description, including alternatives, modifications, and equivalents within the spirit and scope of the inventions. Further, the use of the terms “invention,” “present invention,” “embodiment,” and similar terms throughout the description are used broadly and not intended to mean that the inventions require, or are limited to, any particular aspect being described or that such description is the only manner in which the inventions may be made or used. Additionally, the inventions may be described in the context of specific applications; however, the inventions may be used in a variety of applications not specifically described.

The embodiment(s) described, and references in the specification to “one embodiment”, “an embodiment”, “an example embodiment”, etc., indicate that the embodiment(s) described may include a particular feature, structure, or characteristic. Such phrases are not necessarily referring to the same embodiment. When a particular feature, structure, or characteristic is described in connection with an embodiment, persons skilled in the art may effect such feature, structure, or characteristic in connection with other embodiments whether or not explicitly described.

In the several figures, like reference numerals may be used for like elements having like functions even in different drawings. The embodiments described, and their detailed construction and elements, are merely provided to assist in a comprehensive understanding of the invention. Thus, it is apparent that the present inventions can be carried out in a variety of ways, and does not require any of the specific features described herein. Also, well-known functions or constructions are not described in detail since they would obscure the inventions with unnecessary detail. Any signal arrows in the drawings/figures should be considered only as exemplary, and not limiting, unless otherwise specifically noted. Further, the description is not to be taken in a limiting sense but is made merely for the purpose of illustrating the general principles of the inventions.

It will be understood that, although the terms first, second, etc. may be used herein to describe various elements, these elements should not be limited by these terms. These terms are only used to distinguish one element from another. Purely as a non-limiting example, a first element could be termed a second element, and, similarly, a second element could be termed a first element, without departing from the scope of example embodiments. As used herein, the term “and/or” includes any and all combinations of one or more of the associated listed items. As used herein, the singular forms “a”, “an,” and “the” are intended to include the plural forms as well, unless the context clearly indicates otherwise. It should also be noted that, in some alternative implementations, the functions and/or acts noted may occur out of the order as represented in at least one of the several figures. Purely as a non-limiting example, two figures shown in succession may in fact be executed substantially concurrently or may sometimes be executed in the reverse order, depending upon the functionality and/or acts described or depicted.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Many locations, such as health clubs or gyms, have lockers that are shared by users. The lockers are typically not assigned to the users. When arriving at the facility. the user often has to look for an available locker. Users would prefer to choose a locker that is not adjacent to another locker that is currently being used and hope that an adjacent locker won't be in use when they return to their locker to dress before leaving the facility.

While a user can often initially select a locker that is not adjacent to another locker being used, the user will also use the locker before leaving the facility, and may return to it one or more times in between. Users usually do not have information regarding those using adjacent lockers and it is hard for users to predict if others will be using adjacent lockers when a user returns to the locker room for the final use of their locker. In addition, users often need to remember their locker number when they return to the facility which can be difficult at times.

In at least some embodiments, locker assignment systems and methods can select a particular locker for a particular user. For example, in some embodiments, a user may visit a facility and may wish to make use of a locker during the visit. In some embodiments, the location, such as a health club, can allow users to arrive at facility and use a mobile application to scan in and request to obtain a locker in a locker room. In some embodiments, the locker room can have a number of unused lockers and the locker assignment system can take various factors into account when assigning an unused locker to the user. For example, in at least some embodiments, it is desirable for the locker assignment system to select a locker that is a certain distance from other users. In at least some embodiments, the locker assignment system assigns a locker to a user using data, such that the locker assignment system attempts to minimize, or at least reduce the frequency that a user will be using a locker while someone else is simultaneously using an adjacent locker. In some embodiments, the locker assignment system is able to predict, with some degree of accuracy, when individual users will return to their respected lockers and take this into account when initially assigning the lockers to avoid adjacent locker usage both at a user's arrival to a facility and at a user's departure from the facility.

These systems and methods can be used in various locations, such as but not limited to, gyms, fitness centers, spas, malls, amusement parks and/or other locations where a user may desire to store things for a period of time.

In some embodiments, a user, such as a member of a health club, can use their client computing device such as, but not limited to, a smartphone, laptop, or smartwatch and inform the facility of their anticipated time of needing a locker. In at least some embodiments, the reservation information for most, if not all, the lockers at the facility is known and a locker can be selected for the user. In some embodiments, the locker can be selected based on various factors, including but not limited to, the desired time of usage, historical usage of the user and current usage status of adjacent lockers. In some embodiments, as more data is collected, the locker assignment systems and methods can continue to improve and make better predictions on which locker should be assigned to each user to maximize, or at least increase, the users'positive experiences at the facility.

In some embodiments, locker assignment systems and methods can assign each user a particular locker from a plurality of lockers that can lessen the likelihood of other users being nearby the particular locker while the user is using the particular locker. As an example, in some embodiments, it is possible to start by making certain assumptions about each user and attempt to distribute the users in a way that the users will not interfere with each other. In some embodiments, over time the system can continue to learn from usage data using artificial intelligence, such as machine learning. For example, in some embodiments, at a particular location a given user can have typical days of visits (e.g., Mon-Wed-Fri), time of visits (e.g., 1-3 pm) and/or average length of stays (e.g., 2 hours). In some embodiments, the system can make a recommendation of a particular locker (e.g., locker 123) based on average busyness over a particular day, a particular time for a particular user, and/or historical data of lockers that are traditionally selected at a particular location. In most embodiments, a particular location has an arrangement of lockers that is specific to that location and can also have rooms or environmental objects that may cause users to want to select particular lockers (e.g., a restroom, showers, a sauna, a steam room at a fitness center or a rollercoaster or ride at an amusement park).

In some embodiments, assignment of a particular locker can be based on a request from a user. In some embodiments, the request can include a particular period of time such as one hour, two hours, or three hours, among other options.

In some embodiments, at least some lockers can have a device comprising a client computing device or IoT device that can act as a lock for the locker and/or can communicate with a server computing device. In some embodiments, the device can communicate wirelessly and can send a message or data to the server computing device each time the device changes state from locked to unlocked. In some embodiments, the server computing device can assign each user a particular locker based on state information of the plurality of lockers. In some embodiments, this state information can include whether the locker is locked and unlocked and/or anticipated usage data.

In some embodiments, the server computing device can send locker assignment information to a user's client computing device such as their smartphone or other personal device. In some embodiments, the user does not have to remember their assigned locker number because the system assigns the locker number to the user and provides this information in a form that can be recalled by the user, such as, but not limited to, via an app on their phone.

In some embodiments, the system can use AI software (such as neural networks or other AI systems), optimization software (such as CPLEX, Gurobi, SCIP, another optimization/solver software), and/or proprietary software.

In some embodiments, the server computing device can assign the particular locker based on current and future usage that can be estimated and predicted based on historical information. In some embodiments, it can be desirable to leave a number of unassigned lockers around a particular selected locker for a user. In some embodiments, the server computing device can assign a first locker to a first user and assign a second locker to a second user. In some embodiments, the system can also mark a number of lockers around the first user and/or the second user as “unassignable” meaning that the lockers are not being used to a user but should not be assigned until the first user and/or second user vacates the first locker and/or second locker. In some embodiments, the unassigned lockers can remain unassigned until the first user and/or the second user vacate use of the locker(s) for the first time. At that point, the unassignable adjacent lockers can be added back to a pool of lockers available for assignment. In some embodiments, such as when the facility is busy, the unassignable lockers can be put back into the pool of assignable lockers before the first user and/or second user vacates their respected locker if needed.

In some embodiments, a locker assignment system can include a plurality of lockers each having a locker device comprising a wireless communication device, a memory storing computer-readable instructions, and at least one processor to execute instructions. In some embodiments, these locker devices (and the data they collect) can be used to train a machine learning model using artificial intelligence software, optimization software and/or proprietary software. The data can include visitor usage data for the location having the plurality of locker devices.

In some embodiments, the locker assignment system can receive a request from a user for a locker having one of the locker devices at the particular location for a particular period of time. In some embodiments, the locker assignment system can then select a particular locker from the plurality of lockers for the user based on the machine learning model and/or other software involved. In some embodiments, the locker assignment system can obtain usage information from the locker device for the user for the particular period of time, retrain the machine learning model using the usage information from the locker device for the user for the particular period of time.

In some embodiments, the locker assignment system is predictive as to the usage of lockers in the future and takes that predicted future usage into consideration when assigning lockers. In some embodiments, the locker assignment system takes the amount of time a locker is predicted to be used into account when assigning lockers to eliminate, minimize, or at least reduce, adjacent locker usage both when a user is arriving at the facility and when the user is returning to the locker before leaving the facility.

In some embodiments, the locker assignment system collects various data from users including, but not limited to, when a user scans in at a facility, a user provided estimated time for how long they will need a locker, and/or how long the user actually uses the locker. Typically owners of facilities only have information about when a user scans into the facility.

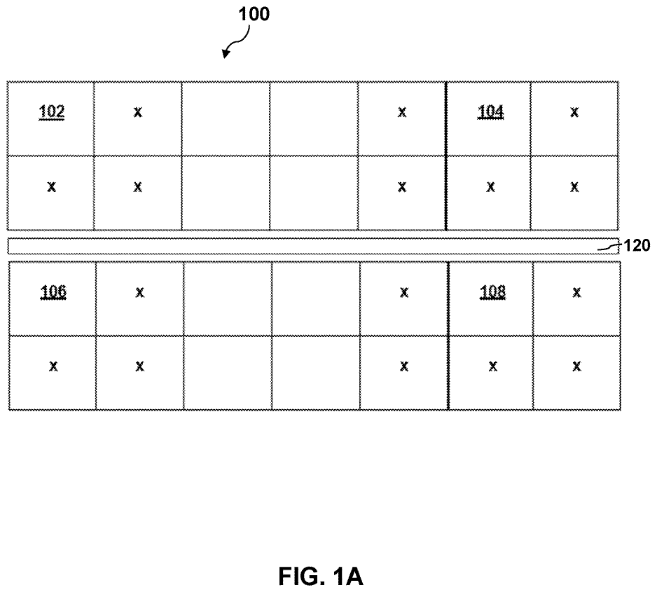

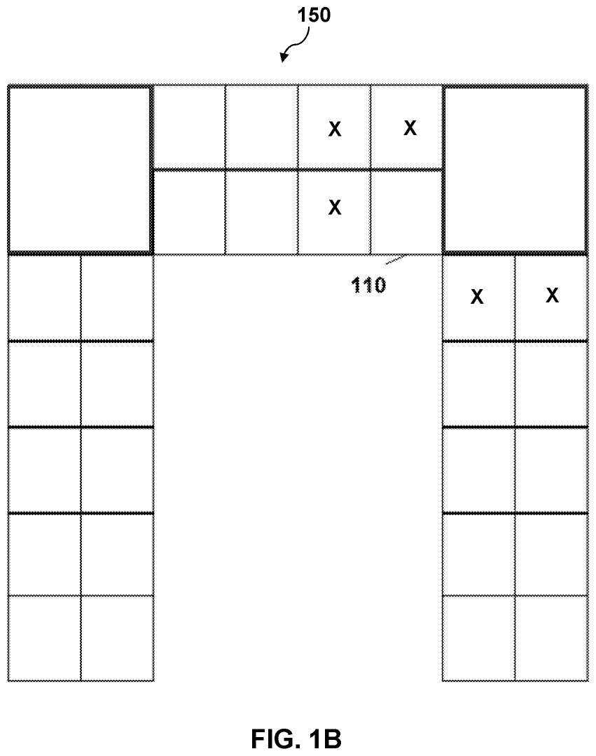

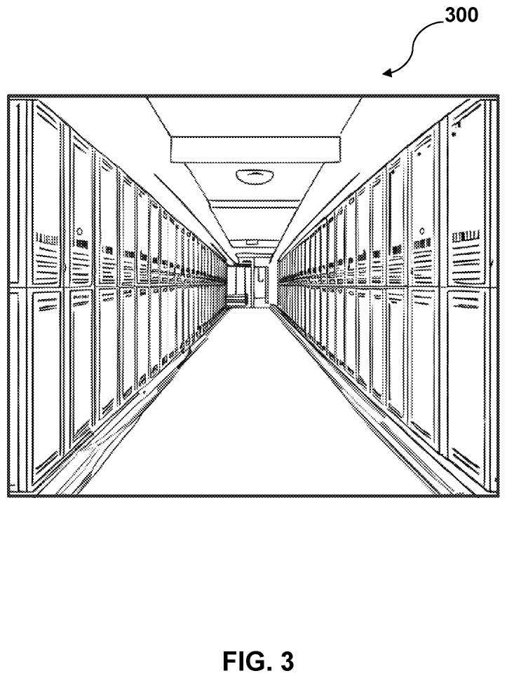

FIG. 1A shows an example of a block of lockers in an example locker room 100. In FIG. 1A there are two rows of lockers with aisle 120 between the two rows. A perspective view of this type of arrangement is shown in FIG. 3.

In some embodiments, either prior to or upon arrival at locker room 100, a user of locker room 100 can be asked to scan in via a device, such as a smartphone or a smartwatch, using a quick-response (QR) code or another method such as near field communication (NFC). In some embodiments, the user can be asked whether they want to reserve a locker upon arrival or before arrival.

In the embodiment shown in FIG. 1A, there are four different lockers that are unoccupied including first locker 102, second locker 104, third locker 106, and fourth locker 108. These lockers can be selected by the locker assignment system for use by users or patrons of the locker room.

As shown in FIG. 1A, locker 102 and locker 106 are end lockers and in some embodiments, require three adjacent lockers, indicated by the x, to not currently be anticipated to be in use during the locker usage time upon arrival and departure of a new user in order to assign locker 102 or locker 106 to that new user. As shown in FIG. 1A locker 104 and locker 108 are located in the middle of a wall of lockers and, in some embodiments, require five other lockers, indicated by the x, to not currently be anticipated to be in use during the locker usage time upon arrival and departure of a new user in order to assign locker 104 or locker 108 to a that new user.

In some embodiments, the locker assignment system also considers lockers located across the aisle from the assigned locker. For example, in some embodiments, if locker 102 is assigned, locker 106 would not be assigned if locker 102 were anticipated to be in use during either the arrival locker usage time or departure locker usage time of a new user.

FIG. 1B shows an example of a block of lockers in an example a locker room section 150. In some embodiments, such as shown in FIG. 1B, locker room section 150 can include a top row of lockers and a bottom row of lockers on a first wall, a top row of lockers and a bottom row of lockers on a second wall perpendicular to the first wall, and a top row of lockers and a bottom row of lockers on a third wall opposite the first wall.

As shown in FIG. 1B, lockers such as locker 110 that are located in the corner of two rows of lockers can be treated as a middle locker by the locker assignment system in at least some embodiments. In some embodiments, there needs to be five adjacent lockers not currently anticipated to be in use during the arrival locker usage time and the departure locker usage time of a new user for a corner locker to be assigned to that new user.

In some embodiments, an adjacent locker set can be defined as the number of lockers (e.g., five) surrounding the locker (assuming a locker is a middle locker). In some embodiments, adjacent lockers can include two lockers to the immediate left and right and one locker immediately above/below the assigned locker and the lockers diagonally to the left and right of the locker.

In some embodiments, for an end locker that is not located at the end of a wall that is met perpendicularly by another wall of lockers there can be three adjacent lockers including one locker immediately to the left/right and one locker above/below the assigned locker and one locker diagonally adjacent to the assigned locker.

In some embodiments, there can be other types of end lockers such as the following four different types. An arrangement of lockers can be dependent upon a particular facility or location and is not limited to the following examples.
(1) end—right—there are no lockers to the right of the locker
(2) end—left—there are no lockers to the left of the locker
(3) end—right—middle—meets other end locker (end—left—middle) on a perpendicular wall to the right of the locker
(4) end—left—middle—meets other end locker (end—right—middle) on a perpendicular wall to the left of the locker

End—right—middle and end—left—middle are treated as middle lockers having 5 adjacent lockers.

For each of the four examples above, there can be a top row and a bottom row.

In some embodiments, the adjacent locker set can be expanded to include lockers not just directly adjacent to a given locker, but also X number of lockers away. In some embodiments, how busy a facility is at a given time can be used to determine how broadly the system defines adjacent lockers. For example, when a facility is not overly busy, it may be desirable for lockers to be placed further apart.

In some embodiments, a locker with the highest grade or score can be chosen as a selected locker from the plurality of available lockers for a user. In some embodiments, if there is a tie, the locker can be assigned at random from the top results of available lockers. In some embodiments, a locker can be chosen based on user preferences associated with a desired location, e.g., a top row locker, a bottom row locker, closest to an entrance, closest to an exit, or closest to a bathroom. In some embodiments, a first “good enough” score can be used for selecting a locker when speed of assignment is of paramount importance such as during extremely busy times or other situations.

In an example, a particular locker selected for a user can be a middle locker and have at least five adjacent lockers, two adjacent horizontally, two adjacent diagonally and one adjacent vertically.

In another example, a particular locker selected for a user can be an end locker and have at least one horizontally adjacent locker, a vertically adjacent locker and a diagonally adjacent locker of the particular locker.

In the example show in FIG. 1A lockers 102, 104, 106, and 108 can represent lockers that can be chosen by the locker assignment system to be spaced apart from other users. Other arrangements are possible. In some embodiments, the system can calculate ways to maximize, or at least increase locker usage.

In some embodiments, for the locker assignment system to accurately assign lockers to increase customer satisfaction, the layout of the locker room and which lockers are preferred has to be considered. In some embodiments, locker assignment systems imports data from a software package that allows for accurate and efficient depictions locker room layouts. In some embodiments, information for end lockers is entered, and the system generates all the middle locker data. In some embodiments, the amenities, and the paths to them are noted. In some embodiments, preferred lockers can be entered based on available member usage data, observation of usage and/or the judgment of the owners and/or installers.

In some embodiments, the locker assignment system is predictive as to the usage of lockers in the future and takes that predicted future usage into consideration when assigning lockers. In some embodiments, the locker assignment system is set up as a system of constraints for determining locker availability and then optimizing algorithms are used to select from the available lockers. In some embodiments, the locker assignment system needs to consider that a given locker room might have, among other things, lockers which are reusable and available to all members, handicapped lockers, special purpose lockers such as for spa customers or other special uses, and/or permanent lockers that are used exclusively by one member.

In some embodiments of the locker assignment systems, L is the set of all lockers that can normally be assigned to members; A is the set of sets of adjacent lockers; L₁ is locker 001; and A₁ is the set of all lockers adjacent to locker L₁. In some embodiments of a locker assignment system, when a member arrives at the facility it is anticipated that they will use their locker initially for X minutes starting from their arrival. In some embodiments of a locker assignment system, to minimize, or at least reduce, adjacent locker usage, it is predicted that the member will be using their locker for Y minutes when they are finishing and leaving the facility. In some embodiments, Y is a multiple of X, such as 2X. In some embodiments of a locker assignment system, this time interval can be centered around the best estimate of the user's return to their locker.

In some embodiments of the locker assignment system, only lockers that are not currently in use are eligible for assignment. In some embodiments of the locker assignment system, if a locker has any adjacent lockers whose projected member time usage intervals overlap with the current member's projected time usage intervals, that locker is ineligible for assignment.

In some embodiments of the locker assignment system taking the above factors into account produces the set of all lockers available for assignment. In many embodiments of the locker assignment system these lockers are not all equal as far as being preferred choices. For example, adjacent lockers whose projected time usage intervals are an hour apart are preferable to those with a shorter duration. In some embodiments of the locker assignment system, having no adjacent lockers in use makes a locker an even better but that is not the only concern.

In some embodiments of the locker assignment system locker preferences are also taken into consideration. In some embodiments, the overall general preferences for certain types of lockers in certain locations in the locker room can be determined. In some embodiments, personal preferences can also be considered but access to that information is not always available.

In some embodiments, once the pool of available lockers is established algorithms are employed to make the ultimate selection. In some embodiments, the speed of the system as well as the day and time will have an impact on the cutoff for an acceptable assignment. In some embodiments, it could be the highest scoring locker whereas at other times it could be the first locker above a certain threshold. In some embodiments, information can be precalculated to speed up the assignment process.

In some embodiments, once the system has generated enough data, AI and/or machine learning models can be tested to determine if they outperform the optimization models. In some embodiments, even if the performance is comparable in the beginning, these models will tend to improve automatically whereas the optimization models will tend to require manual performance tweaks.

In some embodiments, after each visit the member ID, date, time of entry, amount of time reserved, estimated usage time is and/or actual usage time is recorded. In some embodiments, unless a locker has an open/closed sensor, the actual usage time is estimated. In some embodiments of the locker assignment system, the system assumes that a member will reserve a locker for longer than they anticipate using it in case they decide to stay longer than usual. While in some embodiments, the system allows for extending a reservation, those systems may still assume users will reserve a locker for longer than they anticipate using it.

In some embodiments of the locker assignment system actual usage data, or an approximation, can be collected and used to train a machine learning system which is designed to allow the predictive assignment system to better predict a member's actual locker usage time. In at least some embodiments of the locker assignment system, a more precise estimate of the time of a member's final use of the locker allows for a tighter window of anticipated usage which allows for more lockers to be eligible for assignment. In some embodiments, as the system can consider additional lockers, the system will find more acceptable lockers to assign.

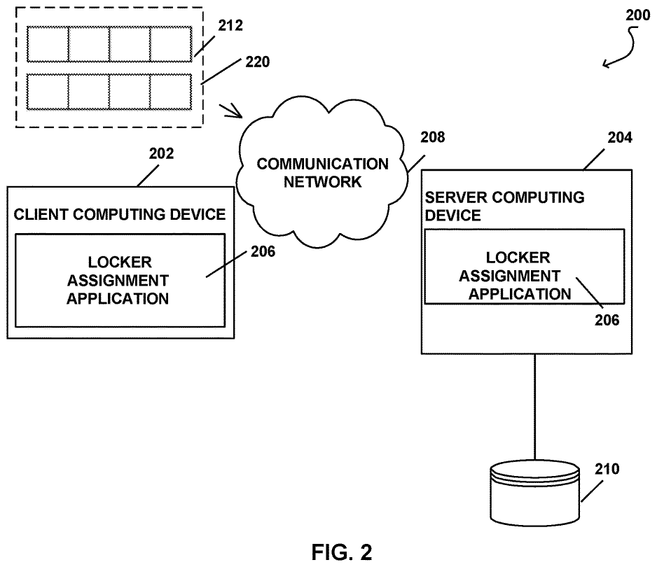

FIG. 2 is a block diagram of an exemplary locker assignment system 200. As shown in FIG. 2, locker assignment system 200 can include at least one client computing device 202 and at least one server computing device 204. In at least some embodiments, the at least one server computing device 204 can be in communication with at least one database 210.

In some embodiments, the at least one client computing device 202 and the at least one server computing device 204 can be configured to receive data from and/or transmit data through communication network 208. As shown in FIG. 2, in at least some embodiments, client computing device 202 and the server computing device 204 are separate devices. It is contemplated that in some embodiments each computing device can include multiple computing devices.

In some embodiments, communication network 208 can be the internet, an intranet, or another wired and/or wireless communication network. In some embodiments, communication network 208 can include a Mobile Communications (GSM) network, a code division multiple access (CDMA) network, 3^{rd} Generation Partnership Project (GPP) network, an Internet Protocol (IP) network, a wireless application protocol (WAP) network, a Wi-Fi network, a Bluetooth network, a near field communication (NFC) network, a satellite communications network, and/or an IEEE 802.11 standards network, as well as various communications thereof. Other conventional and/or later developed wired and wireless networks can also be used.

In some embodiments, most, if not all, lockers in locker room 220 can have locker device 212 that communicates with server computing device 204 using communication network 208. In some embodiments, locker device 212 can be an electronic device capable of communication using communication network 208 and can be a computing device.

In some embodiments, locker device 212 communicates with a collection device that is configured to collect data from one of more locker devices and then utilize communication network 208.

In some embodiments, client computing device 202 and server computing device 204 can have locker assignment application 206 that can be a component of an application and/or service executable by the at least one client computing device 202 and/or the server computing device 204. In some embodiments, locker assignment application 206 can be a single unit of deployable executable code or a plurality of units of deployable executable code. In some embodiments, locker assignment application 206 can include one component that can be a web application, a native application, and/or an application (e.g., an app) downloaded from a digital distribution application platform that allows users to browse and download applications developed with software development kits (SDKs) including the APPLE® iOS App Store and GOOGLE PLAY®, among others. In some embodiments, locker assignment application 206 can be integrated into a facility's application or can be a stand-alone application. In some embodiments, locker assignment application 206 is only located on a facilities server and/or on a second third-party server and end users do not interact directly with application 206 but rather interact via the facility's own application.

In some embodiments, locker assignment system 200 can include one or more data sources that store and communicate data from at least one database 210. In some embodiments, the data stored in the at least one database 210 can be associated with users of locker assignment system 200, usage information for the plurality of lockers in locker room 220, and information associated with a machine learning model or other software for assigning lockers by locker assignment system 200.

In some embodiments, client computing device 202 can include at least one processor to process data and memory to store data. In some embodiments, the processor processes communications, builds communications, retrieves data from memory, and stores data to memory. In some embodiments, the processor and the memory are hardware. In some embodiments, the memory can include volatile and/or non-volatile memory, e.g., a computer readable storage medium such as a cache, random access memory (RAM), read only memory (ROM), flash memory, and/or other memory to store data and/or computer-readable executable instructions. In some embodiments, client computing device 202 further includes at least one communications interface to transmit and receive communications, messages, and/or signals.

In some embodiments, client computing device 202 can be a programmable logic controller, a programmable controller, a laptop computer, a smartphone, a smartwatch, a personal digital assistant, a tablet computer, a standard personal computer, or another processing device. In some embodiments, client computing device 202 can include a display, such as a computer monitor, for displaying data and/or graphical user interfaces. In some embodiments, client computing device 202 can include a Global Positioning System (GPS) hardware device for determining a particular location. In some embodiments, client computing device 202 can include input device, such as one or more cameras or imaging devices, and/or a keyboard or a pointing device (e.g., a mouse, trackball, pen, or touch screen) to enter data into or interact with graphical and/or other types of user interfaces. In some embodiments, the display and the input device can be incorporated together as a touch screen of the smartphone or tablet computer.

In some embodiments, server computing device 204 can include at least one processor to process data and memory to store data. In some embodiments, the processor processes communications, builds communications, retrieves data from memory, and stores data to memory. In some embodiments, the processor and the memory are hardware. In some embodiments, the memory can include volatile and/or non-volatile memory, e.g., a computer readable storage medium such as a cache, RAM, ROM, flash memory, and/or other memory to store data and/or computer-readable executable instructions. In some embodiments, server computing device 204 includes at least one communications interface to transmit and receive communications, messages, and/or signals.

In some embodiments, server computing device 204 is located on premises at the facility, such as a fitness center or gym. In some embodiments, server computing device 204 comprises a cloud computing server computing device. In some embodiments, each facility, such as a fitness center or gym, can have its own server computing device.

In some embodiments, client computing device 202 and server computing device 204 communicate data in packets, messages, or other communications using a common protocol, e.g., Hypertext Transfer Protocol (HTTP) and/or Hypertext Transfer Protocol Secure (HTTPS). In some embodiments, the one or more computing devices can communicate based on representational state transfer (REST) and/or Simple Object Access Protocol (SOAP). For example, in some embodiments, a first computer (e.g., client computing device 202) can send a request message that is a REST and/or a SOAP request formatted using JavaScript Object Notation (JSON) and/or Extensible Markup Language (XML). In response to the request message, a second computer (e.g., server computing device 204) can transmit a REST and/or SOAP response formatted using JSON and/or XML.

In some embodiments, when users first use locker assignment application 206, they can be asked to create an account associated with locker assignment system 200. In some embodiments, a user can provide account information including, but not limited to, name information, physical address information, sex information, an email address, username information, and/or password information. In some embodiments, account information and/or a representation of the account information can be stored in database 210. In some embodiments, the user can be asked to select one or more favorite locations (such as a first health club). In some embodiments, the user can be prompted to provide user profile preference information such as, but not limited to, a type of desired locker (e.g., a locker located on a top row of lockers or a locker located on a bottom row of lockers). For example, a taller person may desire a locker located on the top row of lockers while a shorter person may desire a locker on the bottom row of lockers or vice versa.

In some embodiments, the locker assignment system also may detect trends among the users and apply those trends in assigning lockers even if a user has not indicated a preference. For example, the locker assignment system may determine that men tend to prefer upper tier lockers while women tend to prefer lower tier lockers and start taking this into account when assigning lockers.

In some embodiments, server computing device 204 can be provided information about the layout of the locker room to learn and assign lockers to each user. In some embodiments, the user can be able to view and access real-time busyness information about the locker room and/or facility and/or view and access historical busyness based on a current day and time. In some embodiments, the user can view predicted busyness for future times. In some embodiments, the locker assignment system can use member usage data provided by the facility.

FIG. 3 is a perspective view of example locker room 300. FIG. 3 shows an example arrangement of lockers in an example locker room. As shown in FIG. 3, there can be two rows of lockers along a first wall and two rows of lockers along a second wall opposite the first wall. In addition (while not shown in FIG. 3) there can be two rows of lockers along a third wall that is perpendicular to the first wall and the second wall. In some embodiments, there can be one or more benches between the first wall and the second wall. Other locker room arrangements are possible including walls with one row of lockers, walls with three rows of lockers, walls with four rows of lockers, etc.

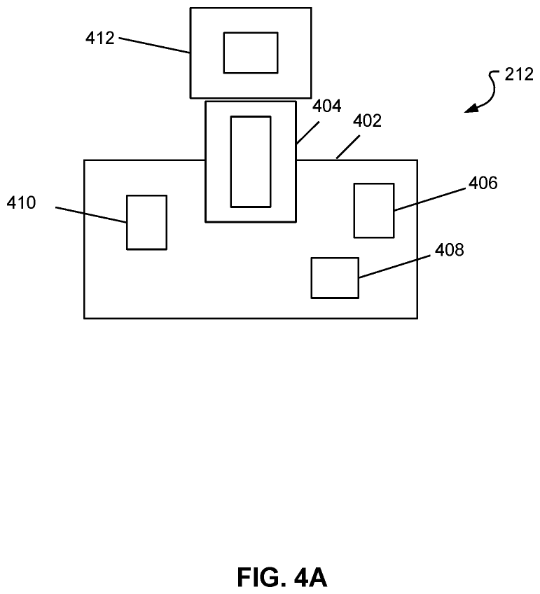

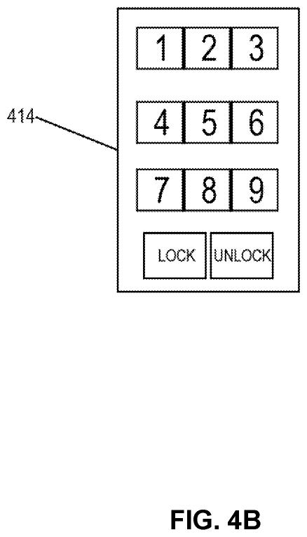

FIG. 4A is a block diagram of an exemplary locker device 212 of locker assignment system 200. As shown in FIG. 4A, locker device 212 can include one or more components that can be installed in a locker in a locker room, such as locker room 220. In some embodiments, a locker can be retrofitted to include locker device 212. In some embodiments, locker device 212 can fit in enclosure 402. In some embodiments, locker device 212 can include one or more radio frequency (RF) communication devices 406 such as an RF module to communicate a state of the locker. In some embodiments, the state of the locker is whether it is locked or unlocked. In some embodiments, the RF module can communicate using Wi-Fi, Bluetooth, Bluetooth Low Energy (BLE), and/or ZigBee, among others. In some embodiments, Wi-Fi is the preferred communication device. In some embodiments, the RF module can communicate the state of the locker wirelessly to a hub device in a message that can forward the message or a representation of the message to server computing device 204. In some embodiments, the RF module can communicate directly to server computing device 204.

In some embodiments, locker device 212 can include power source 408 to power locker device 212. In some embodiments, power source 408 can be one or more batteries. In some embodiments, the power source can be a coin battery such as a 3 V CR2032 coin cell. In some embodiments, the power can be a lithium battery IEC-CR2. In some embodiments, the power source can be a lithium-ion polymer battery such as a 200 mA rechargeable 3.7V lithium-ion polymer battery.

In some embodiments, power source 408 can be a wired power source such as an outlet that powers one or more locker devices 212.

In some embodiments, locker device 212 can have a state detection device 410 that can be one or more sensors to determine the state of the locker. In some embodiments, the one or more sensors can be, among other sensors, a pressure sensor and/or a light sensor. In some embodiments, state detection device 410 can identify whether a particular locker is open or closed. In some embodiments, a sensor can be pressure triggered by closing the locker.

In some embodiments, the locker has an arm that swings behind a latch when locking. In some embodiments, a magnet is attached to the arm and a sensor is installed near the latch. In some embodiments, this sensor records each time the state of the locker changes from unlocked to locked and vice versa. In some embodiments, the sensor is a magnetic sensor. In some embodiments, the sensor timestamps each time the state of the locker changes. In some embodiments, this timestamp is useful in case of a connection loss so the system can resend the data after the connection is reestablished.

In some embodiments, firmware can assist in extending the battery life of locker device 212. In some embodiments, firmware can aid in smart wireless connection switching for locker device 212 to reduce data bandwidth. In some embodiments, locker device 212 can be put into a deep sleep state with wireless module turned off and be configured to wake up upon detecting a change in the sensor, such as a change in the magnetic field. This aids in both extending battery life and reducing multi wireless radio interferences from multiple devices inside the same area.

In some embodiments, locker assignment system 200 can include software to aid in assigning a given locker device 212 to a given locker. In some embodiments, this software is in the form of a mobile application. In some embodiments, this mobile application can be used to assign and configure new locker devices for locker addressing, managing and/or troubleshooting.

In some embodiments, locker assignment system 200 includes Locker Room Layout Software. In some embodiments, Locker Room Layout Software allows facility owners and/or installers of locker devices to place locker and amenities in a virtual layout. In some embodiments, Locker Room Layout Software includes templates for common locker room configurations.

In some embodiments, Locker Room Layout Software allows for drag-and-drop functionality in creating the virtual layout. In some embodiments, Locker Room Layout Software allows for users to specify locker types (e.g., bottom row, top row, end, middle, etc.). In some embodiments, Locker Room Layout Software can include metadata for individual lockers, such as, but not limited to, proximity to showers, exit, amenities etc. In some embodiments, Locker Room Layout Software allows for accurate spatial scaling (e.g., dimensions of lockers and spacing between them). In some embodiments, Locker Room Layout Software allows for integration with grid systems to ensure precise placement. In some embodiments, Locker Room Layout Software allows for users to identify lockers as preferred (e.g., being near amenities) and/or as being less desirable. In some embodiments, Locker Room Layout Software generates layouts in visual formats (such as but not limited to Portable Network Graphic files (PNG) and Portable Document Format files (PDF)) and data formats (such as but not limited to JSON and XML).

In some embodiments, Locker Room Layout Software integrates with predictive locker assignment algorithms. In some embodiments, Locker Room Layout Software supports syncing with predictive locker assignment systems. In some embodiments, Locker Room Layout Software is compatible with IoT-enabled lockers and/or existing management software.

In some embodiments, a collection device is configured to receive locker status data from a plurality of locker devices 212 associated with a plurality of respected lockers. In some embodiments, the collection device is configured to forward locker status data to other components of locker assignment system 200 so it can be analyzed and/or used to further train locker assignment system 200. In some embodiments, the locker assignment system utilizes multiple collection devices. In some embodiments, one or more collection devices connect to the locker assignment system wirelessly. In some embodiments, the collection device is located within thirty meters of the locker devices 212 it collects data from. In some embodiments, a collection device can collect data for up to a hundred lockers which use Bluetooth polling advertising data.

In some embodiments, the collection device can include, among other things a printed circuit board, a wireless microcontroller unit (such as a low power 2.4 GHz Wireless microcontroller unit), a power socket, a power supply (such as a 5V/5 00mA USB power wall adapter power, and/or a housing.

In some embodiments, locker device 212 is a Wi-Fi enabled lock. In some embodiments, the Wi-Fi enabled lock is configured to communicate directly with locker assignment system 200.

In some embodiments, one or more sensors can determine whether a latch, bolt, or locking mechanism 404 is extended into aperture 412 to receive locking mechanism 404 and lock the locker in place and prevent it from being opened and protect the contents therein. In some embodiments, locker device 212 can include a keypad 414, such as shown in FIG. 4B, that can allow the user to enter a code comprising one or more numbers or one or more other characters to set a particular code for the locker that can allow the user to lock and unlock the locker. In some embodiments, the locker can be opened with the user's smart device.

In some embodiments, when the state of the locker changes, locker device 212 can transmit information or data such as a packet of data to server computing device 204. In some embodiments, the state of the locker is comprised of its status as either open or closed and either locked or unlocked. In some embodiments, the packet of data can identify the locker and indicate whether the locker is locked or unlocked. In some embodiments, it can be desirable to wait a particular period of time after the state change, e.g., ten seconds, twenty seconds, thirty seconds, or another amount of time before transmitting the information or data. In some embodiments, this gives a user ample time to vacate the area near a locker after retrieving their items before the system assigns the locker to a new user.

In some embodiments, locker device 212 can include an anti-vandalism mechanism (not shown) to prevent vandalism to the device. In some embodiments, the anti-vandalism mechanism can be attached to locking mechanism 404. In some embodiments, the anti-vandalism mechanism can keep the locking mechanism engaged with aperture 412 to prevent objects from being inserted into locking mechanism 404 and/or aperture 412. In some embodiments, the anti-vandalism mechanism can allow locking mechanism 404 to engage with aperture 412 while preventing foreign objects from being inserted into the locking mechanism 404 and/or aperture 412.

In some embodiments, locker device 212 can include, among other things, a printed circuit board, a microcontroller unit (such as a Wi-Fi microcontroller unit or a Bluetooth low energy microcontroller unit), a sensor, a battery holder, a battery, a housing, a mount mechanism (such as double face tape, glue, and/or mounting screws with corresponding screw holes), and/or a magnet for the latch arm.

In some embodiments, firmware can be deployed to locker devices 212 and/or collection devices via Device Firmware Update technology.

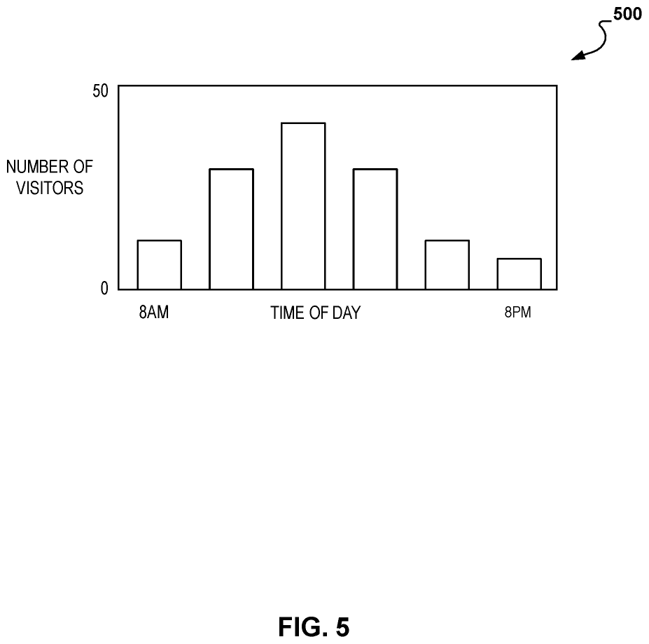

FIG. 5 is a bar graph 500 showing an example usage of locker room 220 or other facility having a plurality of lockers. As shown in FIG. 5, there can be a number of visitors at a particular locker room. For example, there can be a first number of visitors at a first time, a second number of visitors at a second time, a third number of visitors at a third time, a fourth number of visitors at a fourth time, a fifth number of visitors at a fifth time, and a sixth number of visitors at a sixth time during the day. The number of visitors can fluctuate and can form a shape such as a curve that follows the bar graph 500 shown in FIG. 5. As an example, there can be fewer users earlier in the day, a number of visitors that peak at a particular time during the day, and then a lower number of visitors that trails back off later in the day. Historical information such as this can be used by the locker assignment system in determining which locker to assign to a user.

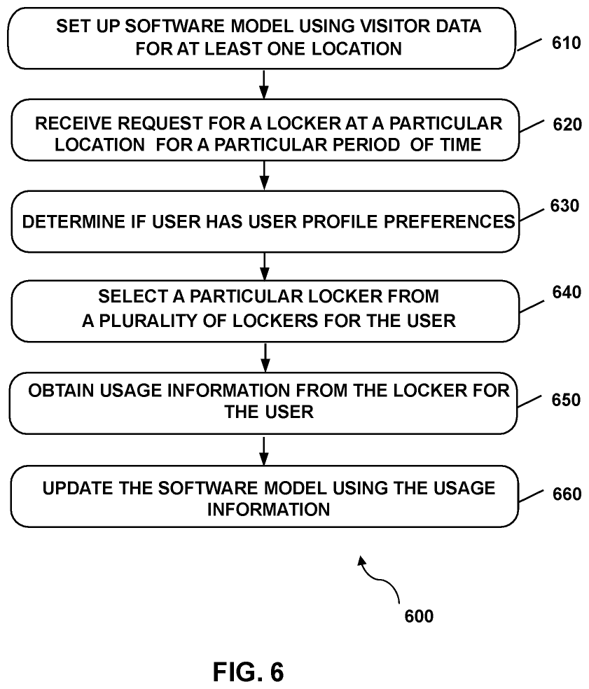

FIG. 6 illustrates an example method for assigning a locker to a user by locker assignment system 200. Although method 600 depicts a particular sequence of operations, the sequence can be altered without departing from the scope of the present disclosure. For example, at least some of the operations depicted can be performed in parallel or in a different sequence that does not materially affect the function of method 600. In other examples, different components of an example device or system that implements method 600 can perform functions at substantially the same time or in a specific sequence.

In at least some embodiments, there can be a plurality of lockers each having locker device 212 that have one or more wireless communication devices. In some embodiments, method 600 includes training a machine learning model or use of other software using visitor usage data for the location having the plurality of locker devices at block 610. In some embodiments, locker device 212 can have state detection device 410 to determine a state of the locker. In some embodiments, this state detection device can determine if the locker is locked or unlocked. In some embodiments, state detection device 410 can be a pressure sensor. In some embodiments, state detection device 410 can be a light sensor. In some embodiments, state detection device 410 can be a magnet sensor.

In some embodiments, method 600 includes receiving a request from a user for a locker having one of locker devices 212 at a particular location for a particular period of time at block 620.

In some embodiments, method 600 includes determining user profile preferences for the user for the location at block 630. In some embodiments, the user preference involves preferences associated with a height of the locker. In some embodiments, the user preferences involve the location of the locker, for example is the locker near a particular amenity. In some embodiments, the user preferences involves being near other users, such as identified friends.

In some embodiments, method 600 includes selecting a particular locker from the plurality of lockers for the user at block 640. In some embodiments, the selection can be based on the machine learning model, other software, and/or on the user profile preferences.

In some embodiments, method 600 includes obtaining usage information from locker device 212 for the user for the particular period of time at block 650.

In some embodiments, method 600 includes retraining the machine learning model or use of other software using the usage information from locker device 212 for the user for the particular period of time at block 660.

In some embodiments, a particular locker can be selected based on a score of each locker, the particular locker having a highest score based on the machine learning model, optimization software, proprietary software, and/or user profile preferences.

In some embodiments, the score is weighted based on real-time current usage of adjacent lockers and/or anticipated future usage of currently unavailable lockers for each locker. In some embodiments, an adjacent locker can be at least one locker next to each locker in each direction (e.g., left, right, top, bottom, diagonal).

In some embodiments, the score is weighted based on future usage of the adjacent lockers for each locker based on an artificial intelligence model or other software.

In some embodiments, the score is weighted based on a probability of the future usage of each adjacent locker for each locker.

In some embodiments, a machine learning model is trained using supervised learning and/or unsupervised learning.

In some embodiments, the particular period of time can be a first period of time, and the visitor usage data indicates a state of each locker device of the plurality of lockers over a second period of time greater than the first period of time.

In some embodiments, the second period of time can be one of one week, one month, three months, six months, and one year, among other shorter periods of time including intraday.

In some embodiments, the particular locker can be a middle locker having at least two adjacent lockers on either the right or left of the particular locker for the particular period of time, and one locker above or below the particular locker for the particular period of time.

In some embodiments, the particular locker can be an end locker having at least one horizontally adjacent locker on either the left or the right of the particular locker for the particular period of time, at least one diagonally adjacent locker on either the left or the right of the particular locker, and one vertically adjacent locker above or below the particular locker for the particular period of time.

In some embodiments, method 600 can include locker device 212 transmitting data including a change in a state of the locker that can be one of locked or unlocked, open or closed, after a waiting period. In some embodiments, the waiting period can be one of ten seconds, twenty seconds, thirty seconds, and at least one minute, among other periods of time.

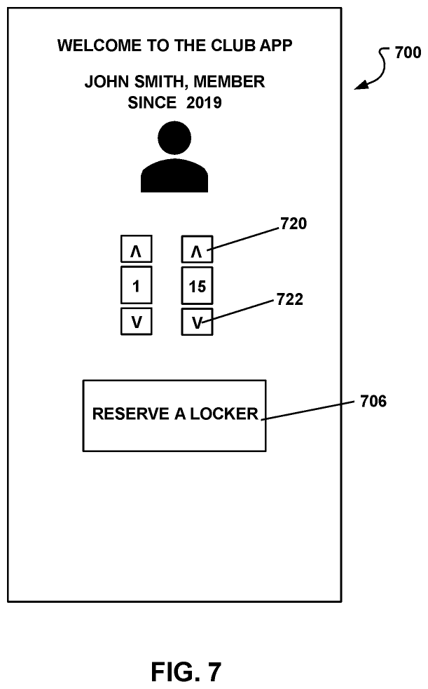

FIGS. 7-11 show example user interfaces provided and displayed by a client computing device 202 that can be used in some embodiments of the locker assignment system.

FIG. 7 shows an embodiment of user interface 700 provided by client computing device 202 which allows a user to request a locker.

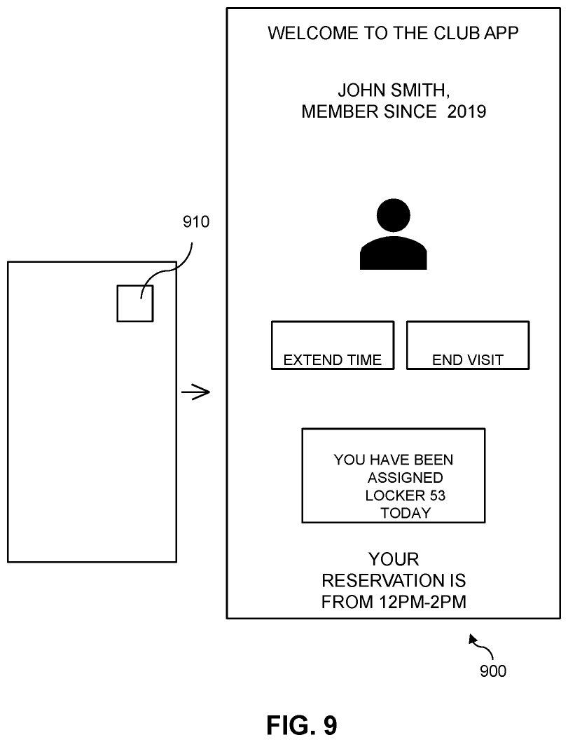

As shown in FIG. 7, the user can select a particular period of time by selecting first graphical user interface element 720 that increases or decreases an amount of time by hours and selecting second graphical user interface element 722 that increases or decreases an amount of time by a particular number of minutes (such as fifteen minutes) to reserve the locker. In some embodiments, a user can select user interface element 706 to reserve a locker. In some embodiments, such as shown in FIG. 9, at a given time period before the reservation ends (e.g., fifteen minutes beforehand), the locker assignment system can send the user an alert and/or notification asking whether the user would like to extend the reservation time. In some embodiments, this notification can be sent as a text message, email and/or via an app. In some embodiments, a user can elect to add additional time to the reservation or let the reservation end.

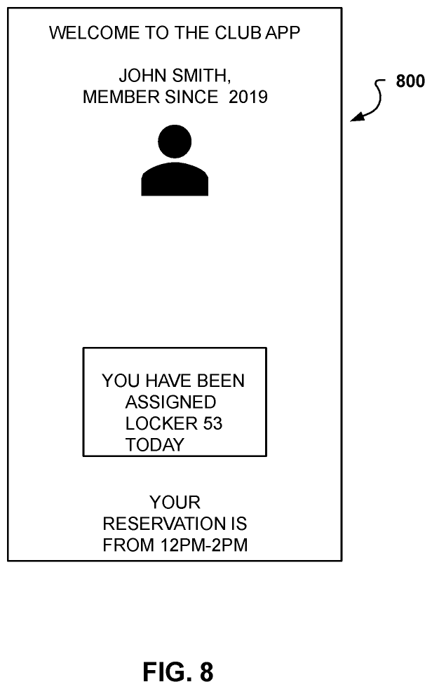

FIG. 8 shows example user interface 800 provided by the client computing device which informs a user of their assigned locker. As shown in FIG. 8, a locker assignment system, such as locker assignment system 200, has reserved and assigned locker 53 for the user and the client computing device 202 displays that the reservation is from 12 PM to 2 PM. In some embodiments, user interface 800 does not include a reservation time.

FIG. 9 shows example user interface 900 provided by the client computing device illustrating how user interface 900 can be accessed via an icon on a smart device, such as a smartphone. As shown in FIG. 9, the user can select icon 910 associated with an application, such as application 206. In some embodiments, this brings up user interface 900 where a user can view information such as, but not limited to, an assigned locker number and/or their reservation time. In some embodiments, a user can extend their reservation and/or end their time early via user interface 900.

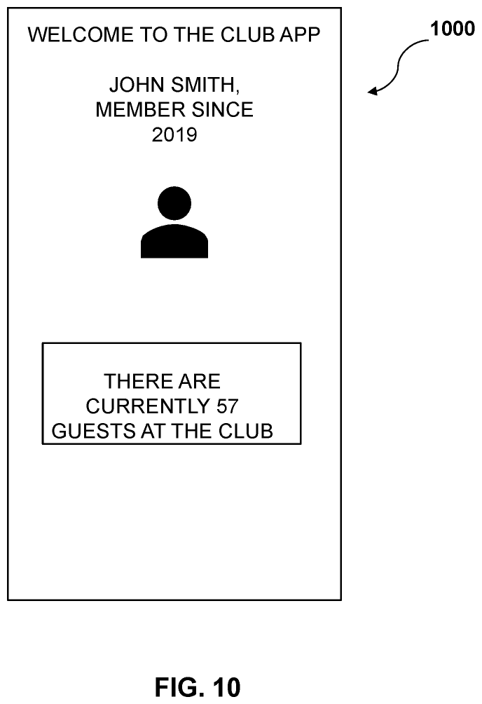

FIG. 10 shows example user interface 1000 provided by the client computing device which shows the current usage of a facility. In some embodiments, such as shown in FIG. 10, a user can view information such as current usage of the facility. Usage can be displayed in different formats such as, but not limited to, a color coded system where different colors correspond to different levels of usage. For example, in some embodiments, green can correspond to low usage, yellow can correspond to medium usage, and red can correspond to high usage.

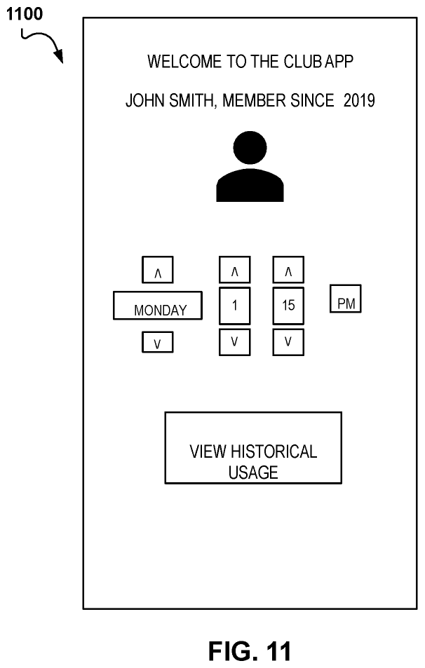

FIG. 11 shows example user interface 1100 provided by the client computing device which shows historical usage of a facility. In some embodiments, such as shown in FIG. 11, a user can view information such as historical usage of the facility by day of the week and/or time. In some embodiments, this information can be displayed graphically for each day showing usage for the entire day. In some embodiments, user interface 1100 can provide predictive usage based on historical usage for future times. In some cases, a user can use this information in determining when to visit the facility.

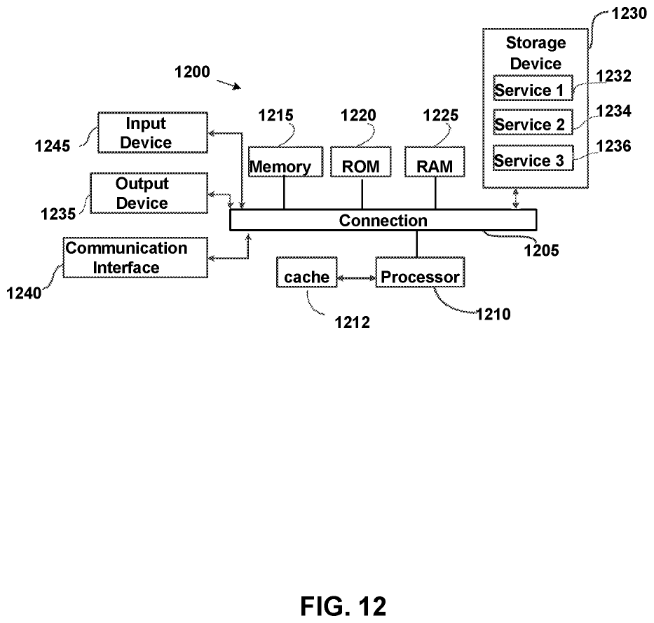

FIG. 12 shows an example of computing system 1200, which can include client computing device 202, server computing device 204, locker device 212, and/or other components. In some embodiments, at least some of the parts of system 1200 are in communication with each other using connection 1205. In some embodiments, connection 1205 is a physical connection via a bus. In some embodiments, connection 1205 is a direct connection into processor 1210, such as in a chipset architecture. In some embodiments, connection 1205 is a virtual connection, networked connection, and/or logical connection.

In some embodiments, computing system 1200 is a distributed system in which at least some of the functions described in this disclosure can be distributed within a datacenter, multiple data centers, a peer network, etc. In some embodiments, one or more of the system components represents many such components each performing some or all of the functions for which the component is described. In some embodiments, the components can be physical or virtual devices.

In some embodiments, computing system 1200 can include at least one processing unit (CPU or processor) 1210 and connection 1205 that couples various system components including, but not limited to, system memory 1215, such as ROM 1220 and/or RAM 1225 to processor 1210. In some embodiments, computing system 1200 can include a cache of high-speed memory 1212 connected directly with, in close proximity to, or integrated as part of processor 1210.

In some embodiments, processor 1210 can include a general purpose processor and a hardware service or software service, such as, but not limited to, service 1232, service 1234, and/or service 1236 stored in storage device 1230. In some embodiments, services 1232, 1234, and/or 1236 are configured to control processor 1210 as well as a special-purpose processor where software instructions are incorporated into the actual processor design. In some embodiments, processor 1210 can essentially be a completely self-contained computing system, containing multiple cores or processors, a bus, memory controller, cache, and/or similar components. In some embodiments, a multi-core processor can be symmetric or asymmetric.

In some embodiments, to enable user interaction, computing system 1200 includes an input device 1245, which can represent a number of input mechanisms, such as a microphone for speech, a touch-sensitive screen for gesture or graphical input, a keyboard, a mouse, a motion input, and/or other input mechanisms. In some embodiments, computing system 1200 can include output device 1235, which can be one or more of a number of output mechanisms. In some embodiments, multimodal systems can enable a user to provide multiple types of input/output to communicate with computing system 1200. In some embodiments, computing system 1200 can include communications interface 1240. In some embodiments, communications interface 1240 can generally govern and manage the user input and system output. It should be noted that there is no restriction on operating on any particular hardware arrangement, and therefore the basic features here can easily be substituted for improved hardware or firmware arrangements as they are developed.

In some embodiments, storage device 1230 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), ROM, and/or some combination of these devices.

In some embodiments, storage device 1230 can include software services, servers, services, etc., that when the code that defines such software is executed by processor 1210, it causes the system to perform a function. In some embodiments, a hardware service that performs a particular function can include the software component stored in a computer-readable medium in connection with the necessary hardware components, such as processor 1210, connection 1205, output device 1235, etc., to carry out the function.

For clarity of explanation, in some instances, the present technology can be presented as including individual functional blocks including functional blocks comprising devices, device components, steps or routines in a method embodied in software, or combinations of hardware and software.

The steps, operations, functions, or processes described herein can be performed or implemented by a combination of hardware and software services or services, alone or in combination with other devices. In some embodiments, a service can be software that resides in memory of a client device and/or one or more servers of a content management system and performs one or more functions when a processor executes the software associated with the service. In some embodiments, a service is a program or a collection of programs that carry out a specific function. In some embodiments, a service can be considered a server. In some embodiments, the memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

In some embodiments, methods according to the disclosed examples can be implemented using computer-executable instructions that are stored or otherwise available from computer readable media. Such instructions can comprise, for example, instructions and data which cause or otherwise configure a general purpose computer, special purpose computer, and/or special purpose processing device to perform a certain function or group of functions. In some embodiments, portions of computer resources used can be accessible over a network. In some embodiments, the executable computer instructions can be, for example, binaries, intermediate format instructions such as assembly language, firmware, or source code. In some embodiments, examples of computer-readable media that can be used to store instructions, information used, and/or information created during methods according to described examples include magnetic or optical disks, solid-state memory devices, flash memory, USB devices provided with non-volatile memory, networked storage devices, and so on.

In some embodiments, devices implementing methods according to these disclosures can include hardware, firmware and/or software. In some embodiments, devices implementing methods according to the disclosure can take a variety of form factors. Some examples of such form factors include, but are not limited to, servers, laptops, smartphones, small form factor personal computers, personal digital assistants, and so on. In some embodiments, the functionality described herein also can be embodied in peripherals or add-in cards. In some embodiments, such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

In some embodiments, a locker assignment system includes a plurality of lockers each having a locker device including a wireless communication device, a memory storing computer-readable instructions, and at least one processor to execute the instructions to train a machine learning model or other software using visitor usage data for a location having the plurality of locker devices, receive a request from a user for a locker having one of the locker devices at the particular location for a particular period of time, select a particular locker from the plurality of lockers for the user based on the machine learning model or other software, obtain usage information from the locker device for the user for the particular period of time, and retrain the machine learning model or other software using the usage information from the locker device for the user for the particular period of time.

In some embodiments the locker assignment system described above includes wherein the locker device comprises a state detection device to determine a state of the locker comprising one of locked and unlocked.

In some embodiments the locker assignment systems described above include wherein the state detection device comprises one of a pressure sensor, a magnetic sensor and/or a light sensor to determine whether the locker is open or closed.

In some embodiments the locker assignment systems described above include a server computing device having the memory storing computer-readable instructions and the at least one processor to execute the instructions.

In some embodiments the locker assignment systems described above include wherein the server computing device comprises one of a server computing device located on-premises at the location and the server computing device comprises a cloud computing server computing device.

In some embodiments the locker assignment systems described above include the at least one processor further to determine user profile preferences for the user for the location and select the particular locker from the plurality of lockers for the user based on the machine learning model or other software and the user profile preferences.

In some embodiments the locker assignment systems described above include wherein the user preferences comprise preferences associated with a height of the locker.

In some embodiments the locker assignment systems described above include wherein the particular locker is selected based on a score of each locker, the particular locker having a highest score based on the machine learning model or other software and the user profile preferences.

In some embodiments the locker assignment systems described above include wherein the score is weighted based on real-time current usage of each adjacent locker for each locker.

In some embodiments the locker assignment systems described above include wherein the score is weighted based on future usage of the adjacent lockers for each locker based on the artificial intelligence model or other software.

In some embodiments the locker assignment systems described above include wherein the score is weighted based on a probability of the future usage of the adjacent lockers for each locker.

In some embodiments the locker assignment systems described above include wherein the machine learning model is trained using at least one of supervised learning, unsupervised learning, and other software.

In some embodiments the locker assignment systems described above include wherein the particular period of time comprises a first period of time, and the visitor usage data indicates a state of each locker device of the plurality of lockers over a second period of time greater than the first period of time.

In some embodiments the locker assignment systems described above include wherein the second period of time comprises one of one week, one month, three months, six months, and one year or much shorter periods of time including intraday.

In some embodiments the locker assignment systems described above include wherein the particular locker comprises a middle locker having at least two vacant adjacent lockers on a right of the particular locker, at least two vacant adjacent lockers on a left of the particular locker for the particular period of time, and one of a vacant locker above the particular locker and a vacant locker below the particular locker for the particular period of time.

In some embodiments the locker assignment systems described above include wherein the particular locker comprises an end locker having at least two vacant adjacent lockers on either the left of the particular locker or the right of the particular locker for the particular period of time and one vacant locker above the particular locker or a vacant locker below the particular locker for the particular period of time.

In some embodiments the locker assignment systems described above include wherein the locker device transmits data comprising a change in a state of the locker comprising one of locked and unlocked after a waiting period.

In some embodiments the locker assignment systems described above include wherein the waiting period comprises one of ten seconds, twenty seconds, thirty seconds, and at least one minute or more.

In some embodiments, a method comprising training, by at least one processor, a machine learning model using visitor usage data for a location having a plurality of locker devices, each locker device comprising a wireless communication device, receiving, by the at least one processor, a request from a user for a locker having one of the locker devices at the particular location for a particular period of time, selecting, by at least one processor, a particular locker from the plurality of lockers for the user based on the machine learning model or other software, obtaining, by at least one processor, usage information from the locker device for the user for the particular period of time, and retraining, by the at least one processor, the machine learning model using the usage information from the locker device for the user for the particular period of time or the use of other software.

In some embodiments, a non-transitory computer-readable storage medium, having instructions stored thereon that, when executed by at least one computing device cause the at least one computing device to perform operations, the operations comprising training a machine learning model or using other software using visitor usage data for a location having a plurality of locker devices, each locker device comprising a wireless communication device, receiving a request from a user for a locker having one of the locker devices at the particular location for a particular period of time, selecting a particular locker from the plurality of lockers for the user based on the machine learning model or other software, obtaining usage information from the locker device for the user for the particular period of time, and retraining the machine learning model, if employed, using the usage information from the locker device for the user for the particular period of time.

What is claimed is:

1. A locker assignment system comprising:
a plurality of lockers wherein each of said plurality of lockers has a corresponding locker device comprising:
a wireless communication;
a memory storing computer-readable instructions; and
an at least one processor to execute the computer-readable instructions to:
train a machine learning model using visitor usage data for a location having said plurality of lockers;
receive a request from a user for a particular locker from the plurality of lockers having said corresponding locker device at said location for a particular period of time;
select said particular locker from the plurality of lockers for the user based on the machine learning model, wherein the particular locker is selected to reduce a likelihood that an adjacent locker will be in use by another user both when the user arrives at the location and when the user returns to the particular locker before departing the location;
obtain usage information from the locker device for the user for the particular period of time; and
retrain the machine learning model or update other software using the usage information from the locker device for the user for the particular period of time.

2. The locker assignment system of claim 1, wherein the locker device comprises a state detection device to determine a state of the particular locker comprising one of locked and unlocked.

3. The locker assignment system of claim 2, wherein the state detection device comprises one of a pressure sensor and a light sensor determining whether the particular locker is open or closed.

4. The locker assignment system of claim 1, further comprising a server computing device having the memory storing computer-readable instructions and the at least one processor to execute the computer-readable instructions.

5. The locker assignment system of claim 4, wherein the server computing device comprises one of a server computing device located on-premises at the location or the server computing device comprises a cloud computing server computing device.

6. The locker assignment system of claim 1, that at least one processor further to determine user profile preferences for the user for the location and select the particular locker from the plurality of lockers for the user based on the machine learning model or other software and the user profile preferences.

7. The locker assignment system of claim 6, wherein the user profile preferences comprise preferences associated with a height of the particular locker.

8. The locker assignment system of claim 6, wherein the particular locker is selected based on a score of each locker, the particular locker having a highest score based on the machine learning model or other software and possibly the user profile preferences.

9. The locker assignment system of claim 8, wherein the score is weighted based on real-time current usage of each adjacent locker for each locker.

10. The locker assignment system of claim 9, wherein the score is weighted based on future usage of at least one adjacent locker for each locker based on the machine learning model.

11. The locker assignment system of claim 10, wherein the score is weighted based on a probability of the future usage of at least one adjacent locker for each locker.

12. The locker assignment system of claim 1, wherein the machine learning model is trained using one of supervised learning and unsupervised learning.

13. The locker assignment system of claim 1, wherein the particular period of time comprises a first period of time, and the visitor usage data indicates a state of each locker device of the plurality of lockers over a second period of time greater than the first period of time.

14. The locker assignment system of claim 13, wherein the second period of time comprises one of one week, one month, three months, six months, and one year.

15. The locker assignment system of claim 1, wherein the particular locker comprises a middle locker having at least two vacant adjacent lockers on the right of the particular locker, at least two vacant adjacent lockers on the left of the particular locker for the particular period of time, and one vacant locker above or below the particular locker for the particular period of time.

16. The locker assignment system of claim 1, wherein the particular locker comprises an end locker having at least two vacant adjacent lockers on either the left of the particular locker or the right of the particular locker for the particular period of time and one of a vacant locker either above or below the particular locker for the particular period of time.

17. The locker assignment system of claim 1, wherein the locker device transmits data comprising a change in a state of the particular locker comprising one of locked or unlocked after a waiting period.

18. The locker assignment system of claim 17, wherein the waiting period comprises one of ten seconds, twenty seconds, thirty seconds, and at least one minute.

19. A method, comprising:
training, by at least one processor, a machine learning model or adjustment of other software using visitor usage data for a location having a plurality of locker devices, each locker device comprising a wireless communication device;
receiving, by the at least one processor, a request from a user for a locker having one of the locker devices at a particular location for a particular period of time;
selecting, by the at least one processor, a particular locker from a plurality of lockers for the user based on the machine learning model or other software configuration,
wherein the particular locker is selected to reduce a likelihood that an adjacent locker will be in use by another user both when the user arrives at the location and when the user returns to the particular locker before departing the location; and
obtaining, by the at least one processor, usage information from a locker device for the user for the particular period of time; and retraining, by the at least one processor, the machine learning model or adjusting another software configuration using the usage information from the locker device for the user for the particular period of time.

20. A non-transitory computer-readable storage medium, having instructions stored thereon that, when executed by at least one computing device cause the at least one computing device to perform operations, the operations comprising:
training a machine learning model or using another software configuration using visitor usage data for a location having a plurality of locker devices, each locker device comprising a wireless communication device;
receiving a request from a user for a locker having one of the locker devices at a particular location for a particular period of time;
selecting a particular locker from a plurality of lockers for the user based on the machine learning model or other software,
wherein the particular locker is selected to reduce a likelihood that an adjacent locker will be in use by another user both when the user arrives at the location and when the user returns to the particular locker before departing the location;
obtaining usage information from the locker device for the user for the particular period of time; and
retraining the machine learning model or adjusting another software configuration using the usage information from the locker device for the user for the particular period of time.
